(19) United States
(12) Patent Application Publication
(10) Pub. No.: US 2022/0044089 A1
(43) Pub. Date: Feb. 10, 2022

(54) MULTI DIGITAL IMAGE LICENSE AND CARD READOUT

(71) Applicant: Eric Murph, Fort Myers, FL (US)

(72) Inventor: Eric Murph, Fort Myers, FL (US)

(21) Appl. No.: 17/073,130

(22) Filed: Oct. 16, 2020

Related U.S. Application Data
(60) Provisional application No. 63/061,452, filed on Aug. 5, 2020.

(51) Int. Cl. G06K 19/077; G06K 19/07

(52) U.S. Cl. CPC G06K 19/07707; G06K 19/0718; G06K 19/0704

(57) ABSTRACT

A personal data storage and display device includes a memory for storing data specific to a user of the device and at least one display screen for displaying data specific to the user of the device. The device further includes at least one sensor and a user interface for interacting with the data displayed by the device. The data displayed by the device may be associated with a plurality of different third-party data sources. The data may include identification data, bank data, or the like.

### FIELD

The present invention relates generally to a device for the storage and maintenance of the personal information of an operator and the subsequent displaying of such personal information upon request, and more specifically, to a portable data storage and display device intended to supplement or replace documents or identification cards normally carried by individuals when traveling or purchasing goods and services,

### BACKGROUND OF THE INVENTION

Consumers generally carry multiple different cards or documents including information specific to that consumer each and every time the consumer leaves his or her home. For example, a consumer will typically carry a wallet, billfold, handbag, pocketbook, clutch, purse, or other carrier that includes multiple different identification cards, bank cards, insurance cards, or the like each time the consumer is traveling, dining, or shopping,

The carrying of so many different cards (and/or similar documents) presents the opportunity for misplacing one or more of the cards each time they are used. For example, one of the many cards may be lost and/or stolen and then misappropriated multiple times before the consumer is even aware of the unauthorized use. This may be especially true if the consumer routinely utilizes various different cards for different situations, depending on the compatibility of the card with the given establishment or the manner in which different cards may present certain rewards or the like when used under certain circumstances. It can accordingly become difficult to monitor the presence and use of each of the various different cards between subsequent uses thereof.

Furthermore, the carrying and use of multiple different cards is also cumbersome in many different situations. For example, it is often difficult to locate a large quantity of these rigid cards within a single carrier without making the carrier difficult to manipulate or uncomfortable to carry (such as an overstuffed wallet). The use of multiple different cards can also render it difficult to find the desired card among the large quantity of cards when it is desired to have a quick interaction when making a purchase or proving the consumer's identity.

Additionally, it is common for some of these cards to now include technology such as radio frequency identification (RFID) chips that allow for remote interactions with various vendors in an attempt to add convenience to the consumer thereof. However, it has been discovered that RHD related information can potentially be stolen (skimmed) in certain situations where the consumer is not even aware that a threat is posed. This greatly limits the utility and desirability of such technology.

Many cards also prominently display the associated consumer's information in a way that can be easily stolen and misappropriated without any additional security features or firewalls. For example, the stealing of a credit card, debit card, and/or driver's license can in many circumstances provide visual access to all of the information needed to steal a consumer's identity or to make illegal purchases in the name of the consumer absent any intervening security measures or features,

It can also be beneficial for the various different types of information specific to the consumer to be readily available in certain emergency situations. For example, an accident may result in the consumer's identity, medical history, and insurance information all being pertinent to giving proper care to the consumer with respect to various fist responders such as law enforcement officials, paramedics, or other healthcare providers.

There is accordingly a continual need for a new and innovative portable device that will help maintain important consumer information, and especially information that is normally subdivided among a large number of different cards and/or documents, in one safe and secure location for selective access by the consumer and/or any persons responsible for the care of the consumer.

### SUMMARY OF THE INVENTION

Consistent and consonant with the present invention, an improved data storage and display device has surprisingly been discovered.

According to an embodiment of the invention, a personal data storage and display device includes a memory for storing data specific to a user of the device and at least one display screen for displaying data specific to the user of the device. The device further includes at least one sensor and a user interface for interacting with the data displayed by the device. The data displayed by the device may be associated with a plurality of different third-party data sources. The data may include identification data, bank data, or the like.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 is a schematic representation of a personal data storage and display device according to an embodiment of the present invention;

FIG. 2 is a front elevational view of the personal data storage and display device showing a front display screen of the device according to one exemplary application of the device; and

FIG. 3 is a rear elevational view of the personal data storage and display device showing a rear display screen of the device according to the exemplary application of the, device as shown in FIG. 2.

### DETAILED DESCRIPTION OF AN EMBODIMENT

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

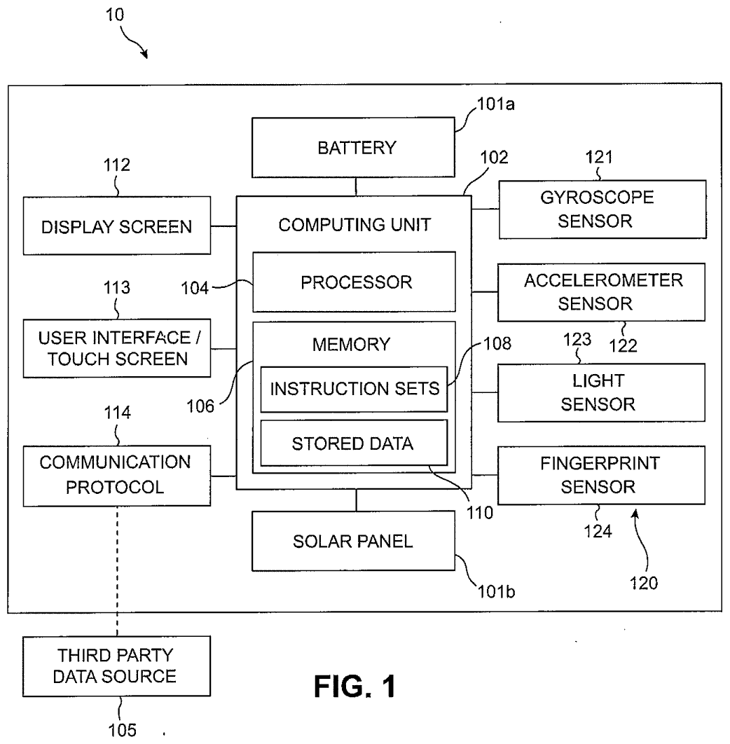

FIGS. 1-3 illustrate a personal data storage and display device 10 according to an embodiment of the present invention, which is referred to as the device 10 hereinafter for brevity. The device 10 includes a housing 12 having a computing unit 102 and all necessary circuitry and sensors for operating the device 10 stored therein. The housing 12 also includes at least one outwardly facing display screen 112 for visually displaying data stored to the device 10. The housing 12 includes a length and width similar to that of any of a variety of different payment cards (credit card, debit etc,), identification cards (driver's license, state ID, military ID, etc.), or other information documents (insurance card, professional licensing card, social security card, business card, etc.) to allow for the device 10 to fit within pockets or receptacles common to wallets, bill folds, purses, etc. The housing 12 may include a thickness significantly less than the width or length thereof, wherein the thickness is minimized while remaining large enough to house the necessary components of the device 10. The at least one display screen 112 may include a front display screen 112a disposed on a first major surface of the housing 12 extending in the length and width dimensions thereof and a rear display screen 112b disposed on an opposing second major surface of the housing 12 also extending in the length and width dimensions thereof.

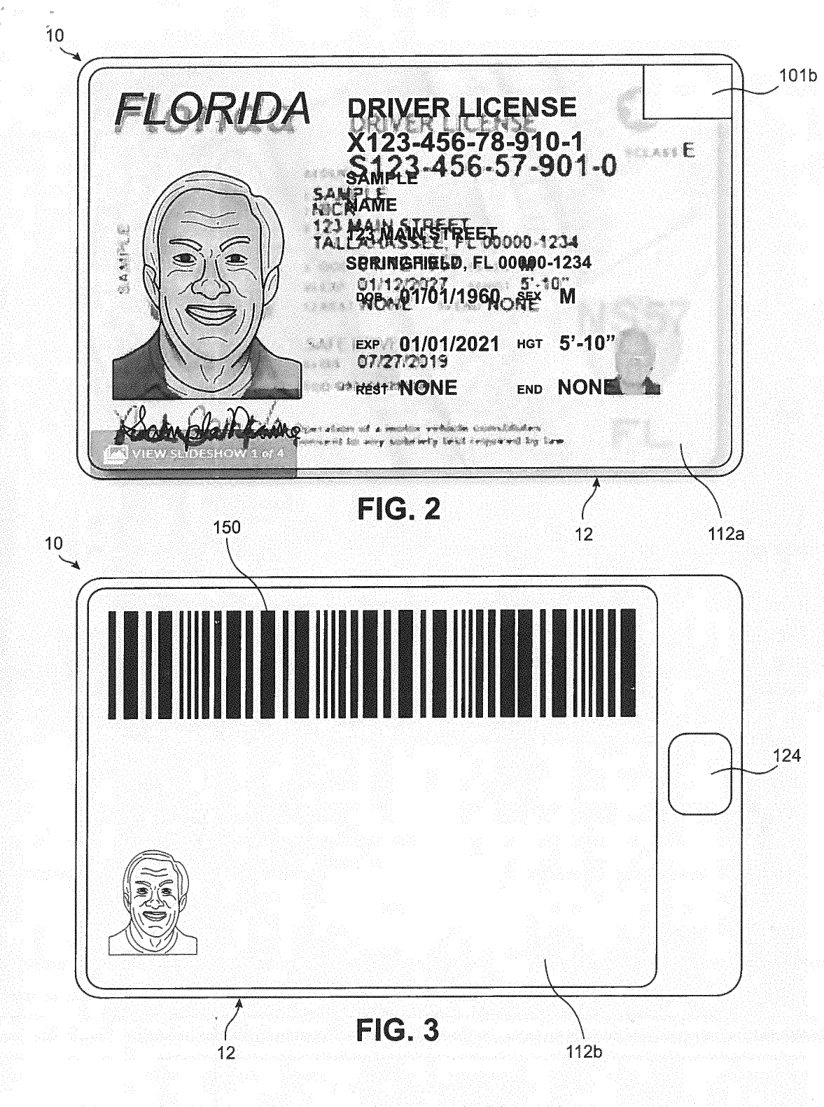

In the example illustrated in FIGS. 2 and 3, the front display screen 112a includes a length and width substantially corresponding to that of the housing 12 to maximize the display area of the front display screen 112a, but the front display screen 112a may alternatively be slightly indented relative to the first major surface of the housing 12. Tile rear display screen 112b is shown as occupying a majority of the second major surface of the housing 12 while indented from one end thereof to allow for space for other features of the invention, but the rear display screen 112b may alternatively occupy the majority or entirety of the second major surface in similar fashion to the front display screen 112a, as desired. Each of the display screens 112a, 112b may be digital color displays having any desired resolution for displaying the data of the device 10. The display screens 112a, 112b may include adjustable back-lighting to ensure that the data displayed by the display screens 112a, 112b can be accessed in a variety of different circumstances including low light conditions.

One or both of the display screens 112a, 112b may also be provided as a touch screen display, to allow for the one or both of the display screens 112a, 112b to be utilized as a user interface 11 of the device 10. Alternatively, the housing 12 may include any necessary buttons or the like for allowing the user of the device 10 to control the information displayed by the display screens 112a, 112b or the inputting of the data utilized by the device 10.

The computing unit 102 may include a processor 104 and a memory 106. The memory 106 may store any data 110 relevant to the use of the device 10 (such as personal data) as well as any instruction sets 108 necessary for carrying out the functions of the device 10 as described hereinafter. The computing unit 102 may include any circuitry or the like for carrying out operations similar to those typical of a smart device such as a smart phone, tablet, smart watch, or the like.

The device 10 is in electrical communication with at least one energy source for powering the computing device 10 and the associated components thereof. The energy sources are provided to allow for the device 10 to be portable and able to be carried and utilized in a variety of different circumstances. The device 10 may include a battery 101a such as a 1.5 volt battery disposed within the housing 12 that can be replaceable and/or rechargeable to allow for the device 10 to be repeatedly useable without interruption. The device 10 may further include a small solar panel 101b for providing auxiliary power to the device 10 or for recharging the battery 101a. The solar panel 101b may be located at a corner or along an edge of the housing 12 or one of the display screens 112a, 112b. For example, the solar panel 101b may be disposed at an upper right-hand corner of the side of the housing 12 including the front display screen 112a.

The computing unit 102 is in signal/electrical communication with various other aspects of the device 10 used for carrying out the functions thereof, including the display screens 112a, 112b, the corresponding user interface 113 a communication protocol 114 for communicating with external devices, and any number of sensors 120 for further interacting with the device 10 during use thereof. The various different components associated with the device 10 may be disposed at positions relative to the housing 12 to ensure a balanced weight of the device 10 for ease of use thereof.

The communication protocol 114 may include any structure or hardware suitable for communicating data between the device 10 and any external data source including any third-party data source 105 responsible for the maintenance and security of the types of data normally displayed by the device 10. The communication protocol 114 may be a wireless communication protocol such as Wi-Fi®er Bluetooth®, as non-limiting examples, or may include a structural interface such as any ports able to be connected to a cord or cable having a port fitting as is typical to traditional smart devices. The communication protocol 114 is configured to receive data from the third-party data source 105 for secure storage and subsequent display by the device 10. The third-party data source 105 may be a state department/bureau of motor vehicles, a bank, an insurance provider, the Social Security Administration, a governmental entity, or the like, as non-limiting examples.

The sensors 120 may include a gyroscope sensor 121 and/or an accelerometer sensor 122 to allow for the orientation, rotation, translation, or the like of the device 10 to be monitored. The monitoring of such movements may be utilized as a type of user interface 113 of the device 10, wherein certain rotations, movements, shakes, or the like of the device 10 indicate various inputs for analysis by the device 10. Such information may be utilized by the computing unit 102 to alter the display of the data shown on the display screens 112a, 112b, as explained in greater detail in the example included hereinafter. A light sensor 123 may be included to allow for the lighting of the display screens 112a, 112b to be altered based on the light conditions daring use of the device 10. The fingerprint sensor 124 may be provided as a security feature to allow only the user associated with the personal data stored to the device 10 to have access to such data for display by the device 10. The fingerprint sensor 124 may be included separately from either of the display screens 112a, 112b or may form a portion of one of the display screens 112a, 112b if the display screens 112a, 112b are utilized in touch screen format as one of the user interfaces 113 of the device 10. However, the fingerprint sensor 124 is shown in FIG. 3 as being disposed in an open space on the second major surface of die housing 12 adjacent the rear display screen 112b. One skilled in the art should appreciate that any variety of relative positions may be utilized while remaining within the scope of the present invention. Although not illustrated in FIG. 1. the device 10 may also optionally include a camera as another security device for determining the person attempting to access the data stored to the device 10.

The device 10 is configured to store the data associated with multiple different third-party data sources 105 such as any of the third-party data sources 105 mentioned above. For example, the device 10 may include driver's license information, bank card information, and insurance card information all stored to the memory 106 of the device 10 as stored data 110. The device 10 may be configured to be toggled to display any of the data sets on the display screens 112a, 112b associated with any of the third-party data sources 105 via any of the user interfaces 113 or interactions mentioned hereinabove. Once selected, the front display screen 112a is configured to display a first set of data associated with the personal data regarding the selected third-party data source 105 while the rear display screen 112b is configured to display a second set of data also associated with the personal data regarding the selected third-party data source 105. The various different sensors 120 or user interfaces 113 associated with the device 10 are then able to be utilized to further manipulate the data displayed or the method of displaying the data in question on the display screens 112a, 112b.

### EXAMPLE

The user of the device 10 associated with the personal data stored thereto may be asked to display data regarding identification of the user, such as when making a purchase or the like. The user may choose to display the information normally associated with the state issued driver's license of the user. The user interacts with the associated user interfaces 113 or sensors 120 to selected the driver's license related information for display. As mentioned above, the user's state of residence may have already communicated with the device 10 via the communication protocol 114 to store the necessary data to the device 10 for subsequent display at the user's request, including any images or categories of data normally associated with a driver's license. The user may utilize a security protocol such as the fingerprint sensor 124 to access the desired data.

As shown in FIG. 2, the front display screen 112a may digitally display the information in a format similar to that associated with a traditional driver's license including the user's photograph, signature, and personal data such as name, address, date of birth, etc. The use of a digital display and various user interfaces may also facilitate additional features that are not common to a traditional driver's license. For example, data may be stored regarding multiple different perspectives of the user's face, including multiple perspectives corresponding to a range of 160 degrees of views of the user's face to allow for display of the user's face from more than one straight on perspective. The user may be able to utilize the gyroscope sensor 121 or the accelerometer sensor 122 to facilitate the changing of the perspective of the images being displayed on the front display screen 112a. In this way, the person inspecting the images can better ascertain the identity of the user due to the additional viewpoints able to be visualized.

As shown in FIG. 3, the rear display screen 112b may also include a barcode 150 or other data for further confirming the data displayed by the device 10. The barcode 150 may be scanned to confirm that the remainder of the data displayed on the front display screen 112a is accurate or properly associated with the specific user of the device 10.

If a purchase is to be made, the device 10 may then be toggled to display bank data or the like on the front display screen 112a and a corresponding security code or the like on the rear display screen 112b. The user may accordingly utilize the device 10 to perform multiple functions using the same structure in a secure and timely manner.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A personal data storage and display device as shown and described herein.

2. A method of using a personal data storage and display device as shown and described herein.

3. A personal data storage and display device comprising:
a memory for storing data specific to a user of the device; and
at least one display screen for displaying data specific to the user of the device.

4. The device of claim 3, further including a power source.

5. The device of claim 4, wherein the power source is at least one of a battery and/or a solar panel.

6. The device of claim 3, further including at least one sensor.

7. The device of claim 6, wherein the at least one sensor is selected from a group including a gyroscope sensor, an accelerometer sensor, a light sensor, and a fingerprint sensor.

8. The device of claim 3, wherein the at least one display screen includes a front display screen and a rear display screen disposed on opposing sides of a housing of the device.
